(19) United States
(12) Patent Application Publication
(10) Pub. No.: US 2017/0156018 A1
(43) Pub. Date: Jun. 1, 2017

(54) Method And Electronic Device For Online Tuning Application

(71) Applicants: Le Holdings (Beijing) Co., Ltd., Beijing (CN); LeCloud Computing Co., Ltd., Beijing (CN)

(72) Inventor: Hongfu Li, Beijing (CN)

(73) Assignees: Le Holdings (Beijing) Co., Ltd., Beijing (CN); LeCloud Computing Co., Ltd., Beijing (CN)

(21) Appl. No.: 15/253,013

(22) Filed: Aug. 31, 2016

Related U.S. Application Data
(63) Continuation of application No. PCT/CN2016/083206, filed on May 24, 2016.

(30) Foreign Application Priority Data
Nov. 30, 2015 (CN) 201510854292.X

(51) Int. Cl. H04W 4/00; G06F 9/445; H04W 8/22

(52) U.S. Cl. CPC H04W 4/001; H04W 8/22; G06F 9/44505; H04W 88/02

(57) ABSTRACT

A method and electronic device for online tuning an application. The method includes: receiving an application tuning request sent by a user terminal; parsing the application tuning request so as to determine a property parameter set of the user terminal; comparing the property parameter set with various index sets in a type reference system, wherein each index set in the type reference system corresponds to one type, determining a plurality of similarities between the property parameter set and the various index sets, and determining the type of the user terminal according to the similarity determination result; and determining an adapted tuning parameter configuration file with reference to a tuning parameter configuration list corresponding to various types in the type reference system according to the determined type of the user terminal and sending the tuning parameter configuration file to the user terminal.

### CROSS REFERENCE TO RELATED APPLICATIONS

This application is a continuation of International Application No. PCT/CN2016/083206, filed on 24 May 2016, which is based upon and claims priority to Chinese Patent Application No. 201510854292.X, filed on 30 Nov. 2015, the entire contents of which are incorporated herein by reference.

### TECHNICAL FIELD

The disclosure relates to the technical field of Internet, and in particular to a method and electronic device for online tuning an application.

### BACKGROUND

With the development of Internet, the P2P services in the video field also increase rapidly, and the application software needs to be updated and upgraded continuously in order to provide better application experience to users.

In the prior art, the publisher of application software has to provide a new version application software installation package regularly or irregularly so as to realize the function upgrading of old version application software. An existing upgrading process of application software usually includes: the software publisher publishes a new version software installation package via various promotion channels, users can download the new version software installation package via various promotion channels and install this new version software installation package in user terminals so as to replace the old version of application software therein to complete upgrading, thus realizing the upgrading of software functions in the user terminal.

However, in the above-mentioned existing solution, each upgrading of the application software is for function expansion or bug repair. Since each application software upgrading cannot take into account the configuration parameters of all current user terminals, the upgraded application software is merely suitable for the running of several most prevailing user terminals at present. However, after the application software is installed in some user terminals with new configuration parameters or some old user terminals, good user experience cannot be obtained.

### SUMMARY

The disclosure provides a method and electronic device for online tuning an application so as to solve the technical problem in the prior art that the upgrading of application software cannot take into account the configuration parameters of all current user terminals.

According to one aspect of the disclosure, a method for online tuning an application is provided, including, at an electronic device:

receiving an application tuning request sent by a user terminal;

parsing the application tuning request so as to determine a property parameter set of the user terminal;

comparing the property parameter set with various index sets in a type reference system, wherein each index set in the type reference system corresponds to one type, determining a plurality of similarities between the property parameter set and the various index sets, and determining the type of the user terminal according to the similarity calculation result; and

determining an adapted tuning parameter configuration file with reference to a tuning parameter configuration list corresponding to various types in the type reference system according to the determined type of the user terminal and sending the tuning parameter configuration file to the user terminal.

In another aspect, an electronic device for online tuning an application is also provided according to an embodiment of the disclosure, including: at least one processor; and a memory communicably connected with the at least one processor for storing instructions executable by the at least one processor, wherein execution of the instructions by the at least one processor causes the at least one processor to execute the method for online tuning an application mentioned above.

According to yet another aspect of the disclosure, provided is a non-transitory computer-readable storage medium storing executable instructions that, when executed by an electronic device, cause the electronic device to execute the method for online tuning an application mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for online tuning an application according to an embodiment of the disclosure;

FIG. 2 is a flowchart of a method for online tuning an application according to another embodiment of the disclosure;

FIG. 3 is a flowchart of a method for online tuning an application according to yet another embodiment of the disclosure;

FIG. 4 is a flowchart of a method for online tuning an application according to still another embodiment of the disclosure;

FIG. 5 is a schematic diagram of a system for online tuning an application according to an embodiment of the disclosure;

FIG. 6 is a schematic diagram of a terminal type determination module according to an embodiment of the disclosure;

FIG. 7 is a schematic diagram of a system for online tuning an application according to another embodiment of the disclosure; and

FIG. 8 is a schematic diagram of a system for online tuning an application according to yet another embodiment of the disclosure;

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

It should be noted that, embodiments of the present application and the technical features involved therein may be combined with each other in case they are not conflict with each other.

The disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The disclosure can be described in a general context where a computer executes computer-executable instructions, such as program modules. Typically, program modules include routines, programs, objects, components, data structures, etc. which perform certain tasks or implement certain abstract data types. The disclosure can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “include”, “include” and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

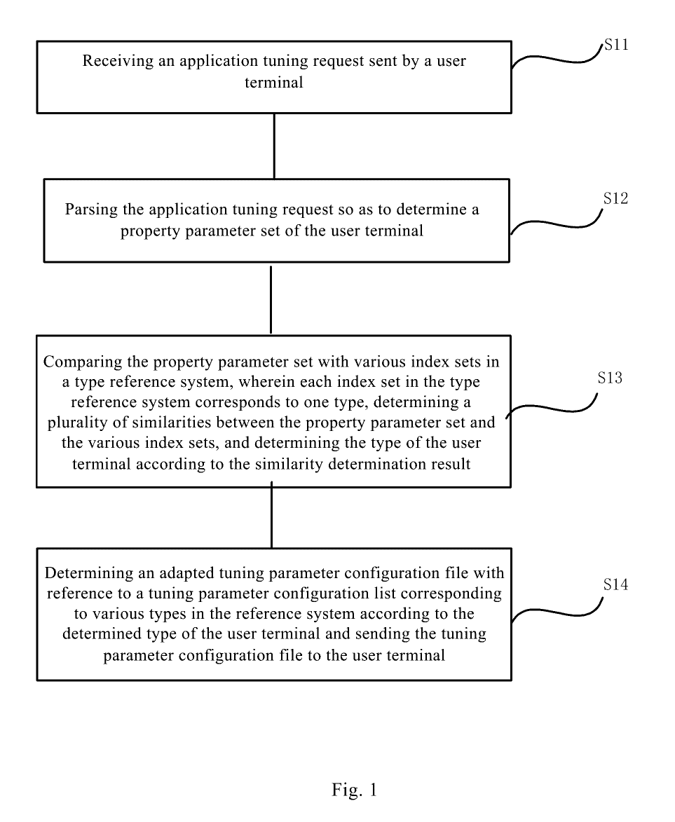

As shown in FIG. 1, a method for online tuning an application according to an embodiment of the disclosure including:

S11, a server receives an application tuning request sent by a user terminal;

S12, the server parses the application tuning request so as to determine a property parameter set of the user terminal;

S13, the server compares the property parameter set with various index sets in a type reference system, wherein each index set in the type reference system corresponds to one type, to determine a plurality of similarities between the property parameter set and the various index sets, and determines the type of the user terminal according to the similarity determination result; and

S14, the server determines an adapted tuning parameter configuration file with reference to a tuning parameter configuration list corresponding to various types in the type reference system according to the determined type of the user terminal, and sends the tuning parameter configuration file to the user terminal.

In this embodiment, the user terminal sends the application tuning request according to a preset period or at the startup of an application loaded in the user terminal. After receiving the application tuning request, the server parses a property parameter set of the user terminal which sends the application tuning request, compares the determined property parameters of the user terminal with various index sets in a known type reference system (each index set corresponds to one type), and determines the terminal type of the user terminal which sends the application tuning request. After determining the terminal type of the user terminal which sends the tuning request, an application tuning parameter configuration file adapted to this terminal type is sent to the user terminal which sends the request with reference to a tuning parameter configuration list corresponding to respective types in the known type reference system, thereby realizing the online tuning of an application installed therein.

In the present embodiments, the user terminal is a intelligent terminal which may be a mobile phone (such as a LeTV mobile phone), or a portable/pocket-size/hand-held/computer embedded/or vehicle carried mobile device, or a PC (personal computer), or a tablet PC, etc., or even an intelligent TV (such as LeTV super TV) which is capable of connecting to internet or a set top box, etc., so that natural information of an object to be identified can be collected through the intelligent terminal.

In some embodiments of the disclosure, after determining a plurality of similarities between the property parameter sets and the various index sets, the type corresponding to an index set associated with a highest similarity in the plurality of similarities which is greater than an upper threshold is determined as the type of the user terminal.

As shown in FIG. 2, in some embodiments, the determination by the server of a plurality of similarities between the property parameter set and the various index sets and determination of the type of the user terminal includes:

S21, the server generates a vector from the property parameter set of the user terminal;

S22, the server determines similarities between the property parameter set and vectors generated for property parameter sets corresponding to various types of user terminals; and

S23, the server determines the type the similarity of which exceeds a first threshold as the terminal type of the user terminal.

In this embodiment, the type of the user terminal which sends the application tuning request is determined according to the similarities between a vector generated for the property parameter set of the user terminal and vectors generated for property parameter sets of known terminal types. In this embodiment, the similarities between the user terminal which sends the application tuning request and the known terminal types are calculated using a cosine similarity algorithm particularly, and when the similarity value exceeds the first threshold, it is determined that the user terminal which sends the application tuning request is of a current known terminal type, wherein the first threshold can be sized according to the requirement on classification accuracy, which is usually 0.8. That is, when the similarity value exceeds 0.8, it is determined that the user terminal which sends the application tuning request is of a current known terminal type.

Since the classification of terminal type is done in advance according to property parameters of user terminals of the whole network, whilst new types of user terminals may appear any time due to the fast updating of user terminals, property parameters of new user terminals will also appear accordingly. When there is a user terminal having new property parameters, a matching terminal type cannot be found according to the pre-counted terminal types. At this time, a new terminal type is established individually and a tuning parameter list of a group of applications will be generated individually for the applications installed in this type of user terminal and configured to a newly created user terminal type configuration file, so that when this type of user terminal appears again in the future, the type thereof can be determined rapidly and a corresponding tuning parameter list is allocated thereto.

The tuning parameter list includes at least one of the following: data processing area selection parameter (local or server end processing), download speed parameter, P2P/CDN selection parameter, P2P buffer size and local buffer control parameter, and the embodiments of the disclosure include, but are not limited to, the above-mentioned parameters. By providing a data processing area selection parameter, calculation-intensive content can be realized locally (i.e., in user terminal) or at the server end during the running of the application.

For example, when the CPU parameter of the user terminal is relatively high, the calculation-intensive content can be placed and realized at the user terminal by setting this parameter so as to relieve the burden of the server, which can facilitate the server to provide better service to other user terminals. If the CPU parameter is relatively low, the calculation-intensive content can be placed and realized at the server by setting this parameter so as to ensure the quality of service for this user.

If the uplink download bandwidth and the downlink download bandwidth in the property parameters are relatively high, a relatively high download speed can be configured for the user terminal through the download speed parameter. When the user is a P2P user or a CDN user and the memory of the user terminal is relatively large, a P2P service or a CDN service can be selected for the user through the P2P/CDN selection parameter and P2P buffer size, and a P2P buffer with suitable size can be allocated thereto.

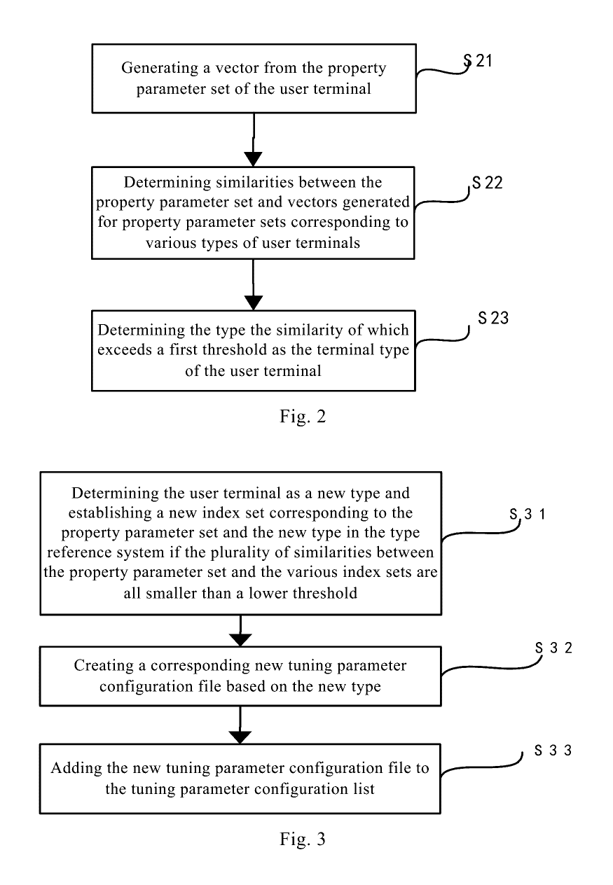

As shown in FIG. 3, in some embodiments of the disclosure, after the server determines a plurality of similarities between the property parameter set and the various index sets,

S31, the server determines that the user terminal is a new type and establishes a new index set corresponding to the property parameter set and the new type in the type reference system if the plurality of similarities between the property parameter set and the various index sets are all smaller than a lower threshold;

S32, the server creates a corresponding new tuning parameter configuration file based on the new type; and

S33, the server adds the new tuning parameter configuration file to the tuning parameter configuration list.

In this embodiment, by establishing a new index set and a new type for a new user terminal and configuring a new tuning parameter configuration file, real-time user terminal type monitoring is realized, the response time to the quality of service is shortened (i.e., a new type of user terminal can be found timely and an optimized application running parameter can be commissioned therefor and pushed thereto), thus the quality of service of all types (existing types or new types of user terminals) are ensured, and user quality is improved.

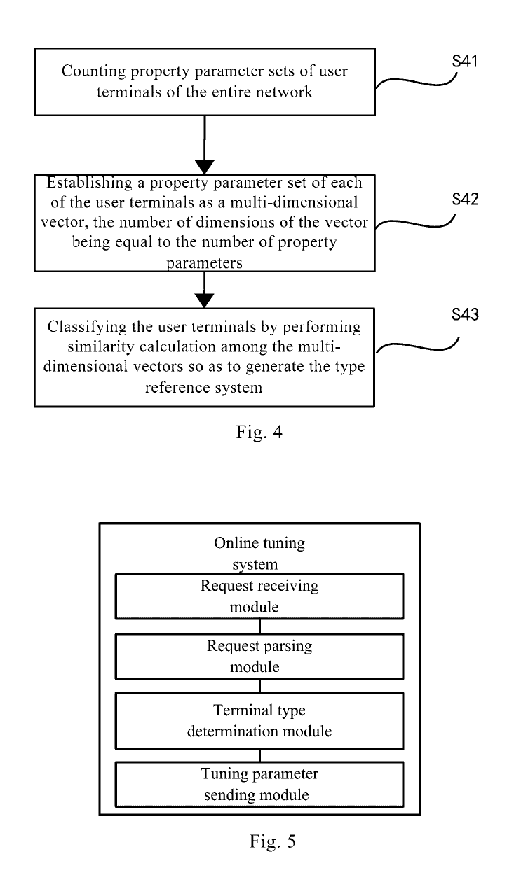

As shown in FIG. 4, in some embodiments, the type reference system is generated through the following steps:

S41, a server counts property parameter sets of user terminals of the whole network;

S42, the server establishes a property parameter set of each of the user terminals as a multi-dimensional vector, the number of dimensions of the vector being equal to the number of property parameters; and

S43, the server classifies the user terminals by performing similarity calculation among the multi-dimensional vectors so as to generate the type reference system.

In this embodiment, the server counts property parameter sets of user terminals of the whole network, establishes a property parameter set of each of the user terminals as a multi-dimensional vector, and then classifies the user terminals by means of the method of calculating the cosine similarities among various multi-dimensional vectors. The quantization of the similarity between two terminals is realized through the similarity calculation method, so that the classification of user terminals is more scientific and accurate.

In any of the above-mentioned embodiments, the property parameters include at least one of CPU parameter, running memory size, storage space size, screen resolution, camera pixels, operating system type, uplink network bandwidth and downlink network bandwidth, and the embodiments of the disclosure are not limited to the above-listed parameters. The developers can make adjustments according to his/her own requirements or the importance of each parameter.

For example, where only CPU parameter, running memory size and storage space size are taken into account, the user terminals can be classified as follows:

first class: CPU parameter-8 cores-1.8 GHz main frequency, running
memory-2 G and storage space-16 G;
second class: CPU parameter-4 cores-1.8 GHz main frequency,
running memory-2 G and storage space-16 G;
third class: CPU parameter-2 cores-2.4 GHz main frequency, running
memory-2 G and storage space-16 G;
fourth class: CPU parameter-2 cores-2.4 GHz main frequency, running
memory-4 G and storage space-16 G;
. . .

The following vectors are generated respectively for the above-mentioned classification:

first vector, [8, 1.8, 2, 16];
second vector, [4, 1.8, 2, 16];
third vector, [2, 2.4, 2, 16];
fourth vector, [2, 2.4, 4, 16];
. . .

If the property parameters uploaded by a new user terminal are: CPU parameter—8 cores—1.8 GHz main frequency, running memory—2G and storage space—32G; then a vector for the property parameters is established: [8, 1.8, 2, 32].

The cosine similarities between this vector and the above-mentioned classification vectors are calculated respectively and the vector the similarity value of which is greater than 0.8 (or the similarity value is self-defined according to particular classification accuracy) is determined as the terminal type corresponding to the corresponding vector.

In this embodiment, the cosine similarity is: taking a property parameter set of a user terminal as a vector in an n-dimensional space, and the similarity between two user terminals are measured by calculating the cosine of the included angle between two vectors.

The user terminals with similar property parameter sets are grouped as one class by means of the similarity algorithm, so that a parameter list can be commissioned for a group of applications suitable for installation on each type of user terminals according to the type thereof and the external network environment as a tuning parameter list. When it is detected that a new user terminal installs this application software, the type of the new user terminal is determined by comparing property parameters of this new user terminal, and a corresponding tuning parameter list therefor is configured, thus realizing the tuning of application software of the new user terminal, so that the user can obtain better user experience when using this application software. This embodiment can be implemented with a single server or can be implemented with a server group.

In the above-mentioned embodiment, the classification of user terminals can be realized through Pearson coefficient or adjusted cosine similarity.

Pearson coefficient is also referred to as relevant similarity, and the similarity between two user terminals is measured through Pearson relevant coefficients. During calculation, vectors of property parameter sets of two user terminals are determined first, and then relevant coefficients of these two vectors are calculated.

Adjusted cosine similarity is to subtract the average of the property parameter sets of the user terminals from the vector in the cosine similarity and then calculate the cosine of the included angle between the two vectors so as to modify the problem that the property parameter sets of different user terminals are different.

In the embodiments of the disclosure, the relevant functional modules can be realized by means of a hardware processor.

It should be noted that the foregoing embodiments of method are described as a combination of a series of actions for the sake of brief description. The skilled of the art could understand that the application is not restricted by the order of actions as described, because some steps may be carried out in other order or simultaneously in the present application. Further, it should also be understood by the skilled in the art that the embodiments described in the description are preferable, and hence some actions or modules involved therein are not essential to the present application.

In the above embodiments, different emphasis is placed on respective embodiments, and hence for those portions without a detailed description in an embodiment, reference can be made to relevant portions in other embodiments.

As shown in FIG. 5, in another aspect, a system for online tuning an application is also provided according to some embodiments of the disclosure, including:

a request receiving module for receiving an application tuning request sent by a user terminal;

a request parsing module for parsing the application tuning request received by the request receiving module so as to determine a property parameter set of the user terminal;

a terminal type determination module for comparing the property parameter set determined by the request parsing module with various index sets in a type reference system, wherein each index set in the type reference system corresponds to one type, determining a plurality of similarities between the property parameter set and the various index sets, and determining the type of the user terminal according to the similarity calculation result; and

a tuning parameter sending module for determining an adapted tuning parameter configuration file with reference to a tuning parameter configuration list corresponding to various types in the type reference system according to the type of the user terminal determined by the terminal type determination module and sending the tuning parameter configuration file to the user terminal.

In this embodiment, the user terminal sends an application tuning request according to a preset period or when an application installed in the user terminal is started up, the request receiving module receives the application tuning request, the request parsing module parses a property parameter set of the user terminal which sends this application tuning request from this request. The terminal type determination module compares the determined property parameter set of the user terminal with various index sets in a known type reference system to determine the terminal type of the user terminal which sends the application tuning request, and after the terminal type of the user terminal which sends the application tuning request is determined, the tuning parameter sending module sends an application tuning parameter configuration file adapted to this terminal type with reference to a tuning parameter configuration list corresponding to various types in the known type reference system, so as to realize the online tuning of the application installed therein.

In this embodiment, the system for online tuning an application is a server or server cluster, in which each module can be a single server or server cluster. As such, interactions among the above-mentioned modules are interactions among the servers or server clusters corresponding to various modules, and a plurality of servers or server clusters constitute the system for online tuning an application in the disclosure.

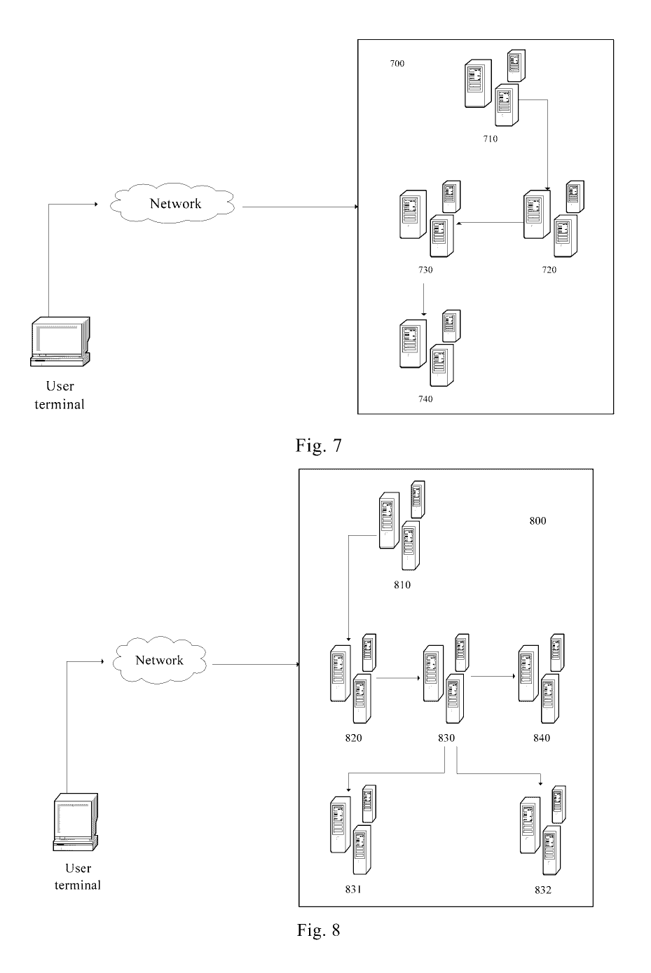

As shown in FIG. 7, in particular, a system 700 for online tuning an application according to this embodiment includes:

a request receiving server or server cluster 710 for receiving an application tuning request sent by a user terminal;

a request parsing server or server cluster 720 for parsing the application tuning request received by the request receiving server or server cluster 710 so as to determine a property parameter set of the user terminal;

a terminal type determination server or server cluster 730 for comparing the property parameter set determined by the request parsing server or server cluster 720 with various index sets in a type reference system, wherein each index set in the type reference system corresponds to one type, determining a plurality of similarities between the property parameter set and the various index sets, and determining the type of the user terminal according to the similarity calculation result; and

a tuning parameter sending server or server cluster 740 for determining an adapted tuning parameter configuration file with reference to a tuning parameter configuration list corresponding to various types in the type reference system according to the type of the user terminal determined by the terminal type determination server or server cluster 730 and sending the tuning parameter configuration file to the user terminal.

In this embodiment, the user terminal is communicatively connected to the online tuning system 700 over a network so as to receive the application tuning request sent by the user terminal.

In an alternative embodiment, several modules in the above-mentioned plurality of modules can constitute a server or server cluster. For example, the request receiving module and the request parsing module constitute a first server or first server cluster, and the terminal type determination module and the tuning parameter sending module constitute a second server or second server cluster.

At this time, interactions among the above-mentioned modules are interactions between the first server and the second server or interactions between the first server cluster and the second server cluster, and the first server and the second server or the first server cluster and the second server cluster together constitute the method for online tuning an application in the disclosure.

In some embodiments of the disclosure, the terminal type determination module includes a first terminal type determination unit for determining the type corresponding to an index set associated with a similarity in the plurality of similarities which is most greater than an upper threshold as the type of the user terminal.

In this embodiment, the firs terminal type determination unit can be a server or server cluster.

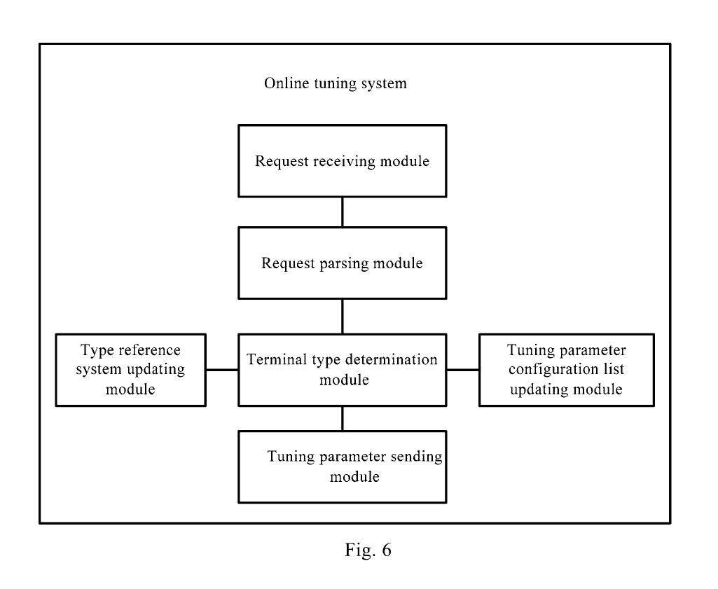

As shown in FIG. 6, in some embodiments of the disclosure, the terminal type determination module is used for determining the type of a terminal associated with a property parameter set the similarities between which and the various index sets are all smaller than a lower threshold as a new one.

The online tuning system further includes a type reference system updating module and a tuning parameter configuration list updating module.

The type reference system updating module is used for, when the terminal type determination module determines a new type, establishing the new type and a new index set corresponding to a property parameter set associated with the new type in the type reference system; and

The tuning parameter configuration list updating module is used for, after the terminal type determination module determines a new type, creating a corresponding new tuning parameter configuration file based on the new type and adding the new tuning parameter configuration file to a tuning parameter configuration list.

In this embodiment, the type reference system updating module and the tuning parameter configuration list updating module can respectively be a server or server cluster, or the type reference system updating module and the tuning parameter configuration list updating module constitute a server or server cluster together.

As shown in FIG. 8, in particular, a system 800 for online tuning an application according to this embodiment includes:

a request receiving server or server cluster 810 for receiving an application tuning request sent by a user terminal;

a request parsing server or server cluster 820 for parsing the application tuning request received by the request receiving server or server cluster 810 so as to determine a property parameter set of the user terminal;

a terminal type determination server or server cluster 830 for comparing the property parameter set determined by the request parsing server or server cluster 820 with various index sets in a type reference system, wherein each index set in the type reference system corresponds to one type, determining a plurality of similarities between the property parameter set and the various index sets, and determining the type of the user terminal according to the similarity calculation result; and

The type reference system updating server or server cluster 831 is used for, when the terminal type determination server or server cluster 830 determines a new type, establishing the new type and a new index set corresponding to a property parameter set associated with the new type in the type reference system; and

The tuning parameter configuration list updating server or server cluster 832 is used for, after the terminal type determination server or server cluster 830 determines a new type, creating a corresponding new tuning parameter configuration file based on the new type and adding the new tuning parameter configuration file to a tuning parameter configuration list.

A tuning parameter sending server or server cluster 840 is used for determining an adapted tuning parameter configuration file with reference to a tuning parameter configuration list corresponding to various types in the type reference system according to the type of the user terminal determined by the terminal type determination server or server cluster 830 and sending the tuning parameter configuration file to the user terminal.

In this embodiment, the user terminal is communicatively connected to the online tuning system 800 over a network so as to receive the application tuning request sent by the user terminal.

Since the classification of terminal types is done in advance according to property parameters of user terminals of the whole network and the updating speed of the user terminals is rapid and there will appearing new user terminals any time, property parameters of new user terminals will also appear. When there is a user terminal having new property parameters, a matching terminal type cannot be found according to the pre-counted terminal types. At this time, a new terminal type is established individually and a tuning parameter list of a group of applications will be generated individually for the applications installed in this type of user terminal and configured to a newly created user terminal type configuration file, so that when this type of user terminal appears again in future, the type thereof can be determined rapidly and a corresponding tuning parameter list is allocated thereto.

The tuning parameter list includes at least one of the following: data processing area selection parameter (local or server end processing), download speed parameter, P2P/CDN selection parameter, P2P buffer size and local buffer control parameter, and the embodiments of the disclosure include, but are not limited to, the above-mentioned parameters. By providing a data processing area selection parameter, calculation-intensive content can be realized locally (i.e., in user terminal) or at the server end during the running of the application.

In some embodiments, the online tuning system also includes a type reference system generation module including:

a parameter set counting unit for counting property parameter sets of whole user terminals in a network;

a multi-dimensional vector establishment unit for establishing a property parameter set of each of the user terminals counted by the parameter set counting unit as a multi-dimensional vector, the number of dimensions of the vector being equal to the number of property parameters; and

a reference system generation unit for classifying the user terminals by performing similarity calculation among the multi-dimensional vectors so as to generate the type reference system.

In this embodiment, the type reference system generation module can be a server or server cluster, in which the parameter set counting unit, the multi-dimensional vector establishment unit and the reference system generation unit are respectively a server or server cluster. As such, interactions among various units are interactions among the servers or server clusters corresponding to respective units.

In an alternative embodiment, several modules in the above-mentioned plurality of modules can constitute a server or server cluster. For example, the parameter set counting unit and the multi-dimensional vector establishment unit constitute a first server or server cluster together, and the reference system generation unit constitutes a second server or second server cluster.

At this time, interactions among the above-mentioned units are interactions between the first server and the second server or the interaction between the first server cluster and the second server cluster.

In the system for online tuning an application in any of the above-mentioned embodiments, the property parameters include at least one of CPU parameter, running memory size, storage space size, operating system type, uplink network bandwidth and downlink network bandwidth.

The method and system for online tuning an application provided in the embodiments of the disclosure can provide a tuning parameter list which is more suitable for the running of an application installed in user terminals having different property parameters (configuration parameters), so as to ensure that an application running in different user terminals has more suitable running parameters, thus ensuring quality of service and improving user experience.

An embodiment of the present application provides a non-transitory computer-readable storage medium storing executable instructions that, when executed by an electronic device, cause the electronic device to execute the method for online tuning an application mentioned above.

In another aspect, the disclosure also provides an online tuning server including:

a memory for storing computer-operable instructions; and

a processor for executing the computer-operable instructions stored in the memory so as to execute the following operations:

receiving an application tuning request sent by a user terminal;

parsing the application tuning request so as to determine a property parameter set of the user terminal;

comparing the property parameter set with various index sets in a type reference system, wherein each index set in the type reference system corresponds to one type, determining a plurality of similarities between the property parameter set and the various index sets, and determining the type of the user terminal according to the similarity determination result; and

determining an adapted tuning parameter configuration file with reference to a tuning parameter configuration list corresponding to various types in the type reference system according to the determined type of the user terminal and sending the tuning parameter configuration file to the user terminal.

The foregoing embodiments of the device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the disclosure can be provided as method, system, or computer program product. Therefore, the disclosure can be implemented in various ways, such as purely by hardware, or purely by software, or a combination of software and hardware. Moreover, the disclosure can be implemented as a computer program product including one or more computer executable program codes which are stored on a computer readable memory medium (including but not limited to a disk storage or optic memory, etc.).

The disclosure is described in reference to method, device (or system), and flow chart and/or block diagram of computer program product of embodiment of the invention. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for online tuning an application, comprising, at an electronic device:
receiving an application tuning request sent by a user terminal;
parsing the application tuning request to determine a property parameter set of the user terminal;
comparing the property parameter set with various index sets in a type reference system, wherein each index set in the type reference system corresponds to one type, determining a plurality of similarities between the property parameter set and the various index sets, and determining the type of the user terminal according to the similarity determination result; and
determining an adapted tuning parameter configuration file with reference to a tuning parameter configuration list corresponding to various types in the type reference system according to the determined type of the user terminal, and sending the tuning parameter configuration file to the user terminal.

2. The method for online tuning an application according to claim 1, further comprising, after determining a plurality of similarities between the property parameter set and the various index sets,
determining the user terminal as a new type and establishing a new index set corresponding to the property parameter set and the new type in the type reference system if the plurality of similarities between the property parameter set and the various index sets are all smaller than a lower threshold;
creating a corresponding new tuning parameter configuration file based on the new type; and
adding the new tuning parameter configuration file to the tuning parameter configuration list.

3. The method for online tuning an application according to claim 1, further comprising, after determining a plurality of similarities between the property parameter set and the various index sets,
determining the type corresponding to an index set associated with a similarity in the plurality of similarities which is most greater than an upper threshold as the type of the user terminal.

4. The method for online tuning an application according to claim 1, wherein the type reference system is generated through the following steps:
counting property parameter sets of user terminals of the whole network;
establishing a property parameter set of each of the user terminals as a multi-dimensional vector, the number of dimensions of the vector being equal to the number of property parameters; and
classifying the user terminals by performing similarity calculation among the multi-dimensional vectors to generate the type reference system.

5. The method for online tuning an application according to claim 1, wherein the property parameters comprise at least one of CPU parameter, running memory size, storage space size, operating system type, uplink network bandwidth and downlink network bandwidth.

6. An electronic device for online tuning an application, comprising at least one processor, and a memory communicably connected with the at least one processor for storing instructions executable by the at least one processor, wherein execution of the instructions by the at least one processor causes the at least one processor to:
receive an application tuning request sent by a user terminal;
parse the application tuning request so as to determine a property parameter set of the user terminal;
compare the property parameter set with various index sets in a type reference system, wherein each index set in the type reference system corresponds to one type, determine a plurality of similarities between the property parameter set and the various index sets, and determine the type of the user terminal according to the similarity determination result; and
determine an adapted tuning parameter configuration file with reference to a tuning parameter configuration list corresponding to various types in the type reference system according to the determined type of the user terminal and send the tuning parameter configuration file to the user terminal.

7. The electronic device for online tuning an application according to claim 6, wherein execution of the instructions by the at least one processor further causes the at least one processor to:
determine the type of a terminal associated with a property parameter set the similarities between which and the various index sets are all smaller than a lower threshold as a new one;
establish the new type and a new index set corresponding to a property parameter set associated with the new type in the type reference system; and
create a corresponding new tuning parameter configuration file based on the new type and add the new tuning parameter configuration file to a tuning parameter configuration list.

8. The electronic device for online tuning an application according to claim 6, wherein execution of the instructions by the at least one processor further causes the at least one processor to:
determine the type corresponding to an index set associated with a similarity in the plurality of similarities which is most greater than an upper threshold as the type of the user terminal.

9. The electronic device for online tuning an application according to claim 6, wherein execution of the instructions by the at least one processor further causes the at least one processor to:
count property parameter sets of user terminals of the whole network; establish a property parameter set of each of the user terminals as a multi-dimensional vector, the number of dimensions of the vector being equal to the number of property parameters; and classify the user terminals by performing similarity calculation among the multi-dimensional vectors so as to generate the type reference system.

10. The electronic device for online tuning an application according to claim 6, wherein the property parameters comprise at least one of CPU parameter, running memory size, storage space size, operating system type, uplink network bandwidth and downlink network bandwidth.

11. A non-transitory computer-readable storage medium storing executable instructions that, when executed by an electronic device, cause the electronic device to:
receive an application tuning request sent by a user terminal;
parse the application tuning request so as to determine a property parameter set of the user terminal;
compare the property parameter set with various index sets in a type reference system, wherein each index set in the type reference system corresponds to one type, determine a plurality of similarities between the property parameter set and the various index sets, and determine the type of the user terminal according to the similarity determination result; and
determine an adapted tuning parameter configuration file with reference to a tuning parameter configuration list corresponding to various types in the type reference system according to the determined type of the user terminal and send the tuning parameter configuration file to the user terminal.

12. The non-transitory computer-readable storage medium for online tuning an application according to claim 11, wherein execution of the instructions by the electronic device further causes the electronic device to:
determine the type of a terminal associated with a property parameter set the similarities between which and the various index sets are all smaller than a lower threshold as a new one;
establish the new type and a new index set corresponding to a property parameter set associated with the new type in the type reference system; and
create a corresponding new tuning parameter configuration file based on the new type and add the new tuning parameter configuration file to a tuning parameter configuration list.

13. The non-transitory computer-readable storage medium for online tuning an application according to claim 11, wherein execution of the instructions by the electronic device further causes the electronic device to determine the type corresponding to an index set associated with a similarity in the plurality of similarities which is most greater than an upper threshold as the type of the user terminal.

14. The non-transitory computer-readable storage medium for online tuning an application according to claim 11, wherein execution of the instructions by the electronic device further causes the electronic device to count property parameter sets of user terminals of the whole network; establish a property parameter set of each of the user terminals as a multi-dimensional vector, the number of dimensions of the vector being equal to the number of property parameters; and classify the user terminals by performing similarity calculation among the multi-dimensional vectors so as to generate the type reference system.

15. The non-transitory computer-readable storage medium for online tuning an application according to claim 11, wherein the property parameters comprise at least one of CPU parameter, running memory size, storage space size, operating system type, uplink network bandwidth and downlink network bandwidth.
